(19) United States
(12) Patent Application Publication
(10) Pub. No.: US 2013/0031035 A1
(43) Pub. Date: Jan. 31, 2013

(54) LEARNING ADMISSION POLICY FOR OPTIMIZING QUALITY OF SERVICE OF COMPUTING RESOURCES NETWORKS

(71) Applicants: Arroyo Diana Jeanne, Austin, TX (US); Zohar Feldman, Haifa (IL); Michael Masin, Haifa (IL); Malgorzata Steinder, Leonia, NJ (US); Asser Nasreldin Tantawi, Somers, NY (US); Ian Nicholas Whalley, Yorktown Heights, NY (US)

(72) Inventors: Arroyo Diana Jeanne, Austin, TX (US); Zohar Feldman, Haifa (IL); Michael Masin, Haifa (IL); Malgorzata Steinder, Leonia, NJ (US); Asser Nasreldin Tantawi, Somers, NY (US); Ian Nicholas Whalley, Yorktown Heights, NY (US)

(73) Assignee: International Business Machines Corporation, Armonk, NY (US)

(21) Appl. No.: 13/194,950

(22) Filed: Jul. 31, 2011

(51) Int. Cl. G06F 15/18

(52) U.S. Cl. 706/12

(57) ABSTRACT

A system for learning admission policy for optimizing quality of service of computer resources networks is provided herein. The system includes a statistical data extractor configured to extract historical data of deployment requests issued to an admission unit of a computer resources network. The system further includes a Markov decision process simulator configured to generate a simulation model based on the extracted historical data and resources specifications of the computer resources network, in terms of a Markov decision process. The system further includes a value function generator configured to determine a value function for deployment requests admissions. The system further includes a machine learning unit configured to train a classifier based on the simulation model and the value function, to yield an admission policy usable for processing incoming deployment requests.

### BACKGROUND

1. Technical Field

The present invention relates to computing resources networks and more particularly, to optimization of deployment requests issued to such networks.

2. Discussion of the Related Art

In recent years, Cloud computing has become a real alternative to traditional computing, by providing a large variety of computing resources, all accessible to users via the Web. Regularly, deployment requests made by users arrive to the Cloud system; each can be characterized by a stochastic arrival rate, lifetime distribution, resource requirements, and profit. The Cloud, (being, in a non-limiting example, a hosting system) typically includes several nodes or physical machines each associated with a resource of a limited capacity.

One of the challenges of Cloud computing is how to deal effectively with deployment requests of users. Since resources are limited, it is very likely that the Cloud system will not be able to admit all of the requests, and some portion of the requests will have to be rejected due to insufficient resources. In order to optimize the performance, it might be desirable to reject requests although they can be hosted in order to allow future preferred requests to be hosted.

Current solutions to this challenge include priority settings for preferred deployments, static reservation of resources for preferred deployments and dynamic future reservation. The priority setting assumes knowledge on future arrivals at the time of decision. Static reservation methods pre-determine the resource capacity to set aside for potential deployments of preferred deployments. Dynamic future reservation is more efficient in the sense that it only blocks deployments when the utilization is high. Both reservation methods are sub-optimal and they do not explicitly take into account the characteristics of the system such as arrival rate distribution, and lifetime distribution. Moreover, calculating the best reservation parameters is not trivial.

### BRIEF SUMMARY

In order to overcome the drawbacks of the existing solutions for the aforementioned deployment requests challenge in a Cloud system, embodiments of the present invention provide an alternative approach. In accordance with the alternative approach, the specific characteristics of the Cloud system are learnt from historical data and based on these parameters a mathematical model in the form of Markov decision process is created in order to provide an optimal admission policy. In a data gathering stage, embodiments of the invention run offline and produce a policy that can be used later in a real-time admission stage.

One aspect of the present invention provides a system for learning admission policy for optimizing quality of service of computer resources networks. The system includes a statistical data extractor configured to extract historical data of deployment requests issued to an admission unit of a computer resources network. The system further includes a Markov decision process simulator configured to generate a simulation model based on the extracted historical data and resources specifications of the computer resources network, in terms of a Markov decision process. The system further includes a value function generator configured to determine a value function for deployment requests admissions. The system further includes a machine learning unit configured to train a classifier based on the simulation model and the value function, to yield an admission policy usable for processing incoming deployment requests.

Other aspects of the invention may include a method arranged to execute the aforementioned system and a computer readable program configured to execute the aforementioned system. These, additional, and/or other aspects and/or advantages of the embodiments of the present invention are set forth in the detailed description which follows; possibly inferable from the detailed description; and/or learnable by practice of the embodiments of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an exemplary system according to some embodiments of the invention; and

FIG. 2 is a high level flowchart diagram illustrating a method according to some embodiments of the invention;

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “computer resources network” sometimes referred to in the computing industry as “cloud” or “cloud computing” is used in the context of this application to a network of computers that includes a variety of distributed computer resources which are accessible to a plurality of users usually via secured communication links. The resources may include anything from processing resources such as central processing units (CPUs) to volatile memory such as Random Access Memory (RAM) and non-volatile memory such as magnetic hard disks and the like. Additionally, the resources may also include software accessed and delivered according to the software as a service (SaaS) paradigm.

The term “deployment request” as used herein in this application refers to any request made by a user of the aforementioned computing resources network in which one or more computer resources are sought, typically in the form of a virtual machine. Such a request is usually being processed by an admission unit that determines how to cater for such a request.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

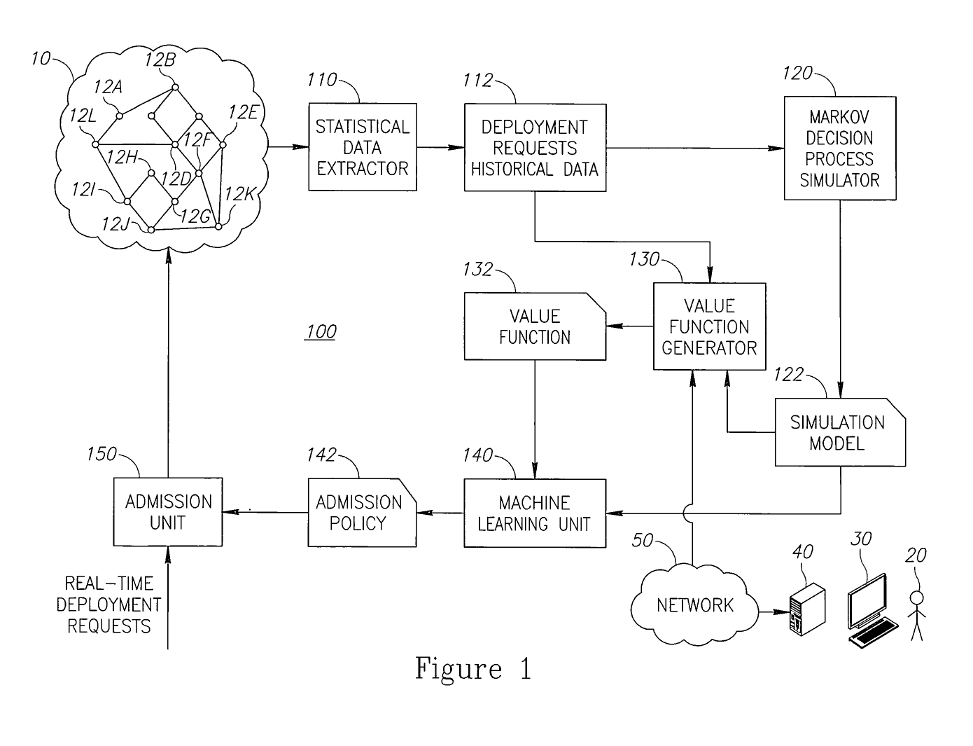

FIG. 1 is a high level schematic block diagram illustrating an environment in which a non-limiting exemplary system 100 may be implemented in a user-server configuration according to some embodiments of the present invention and addressable over a network 50 using a client computer 40 and display 30 with which user 20 interacts. System 100 is configured for learning admission policy for optimizing quality of service of computing resources network 10 which may be in a form of a hosting system or any type of Cloud system that provides distributed computing resources. Computing resources network 10 may include a large variety of hardware and software computing resources such as storage resources, memory resources, processing resources, and various software modules.

System 100 may include a statistical data extractor 110 that may be configured to extract historical data 112 of deployment requests issued to an admission unit 150 associated with computing resources network 10. The system may further include a Markov decision process simulator 120 configured to generate a simulation model 122 based on the extracted historical data 112 and resources specifications (not shown) derived from computing resources network 10. Simulation model 122 may be constructed in terms of a Markov decision process. Specifically, simulation model 122 may be indicative of a Markov decision process in which transition probabilities and a reward function are based upon the extracted historical data 112.

System 100 may further include a value function generator 130 configured to determine a value function 132 for deployment requests admissions. Consistent with some embodiments of the present invention, value function generator 130 may be further configured to generate value function 132 based on any combination of the following data: simulation model 122, historical data 112, and an input from a user 20. The input from user 20 may be used in order to devise various value functions responsive to different Quality of Service (QoS) metrics that may be used in different scenarios. User may effectively apply a different priority to the QoS metrics thus generating an ad hoc value function. It is understood that profit is merely an example for a QoS metric and other metrics may be taken alone, or in combination, in order to provide an appropriate QoS addressing characteristics of a specific computing resources network 10.

System 100 may further include a machine learning unit 140 configured to train a classifier based on simulation model 122 and value function 132, to yield an admission policy 142 usable for processing incoming deployment requests. Consistent with some embodiments of the present invention, the classifier may be implemented, in a non-limiting example, as a decision tree with the set of states depicted by a vector of features, such as the number of hosted virtual machines on each type on each physical machine on computing resources network 10 and their optimized decision. Advantageously, the decision tree can be used to infer admission policy 142 represented by simple rules usually with one or more conditions that are easily checked based on data already present from the gathering of historical data 112. A non-limiting exemplary rule of admission policy 142 may be constructed in the form of: “if the type of request is “A” and there are at least N physical machines with disk space larger than M Megabytes than admit; otherwise reject”. The simplicity of the aforementioned rule exemplifies the ease of implementation of admission policy 142 needed for real time operation. It is understood that many rules need to be constructed similarly, in order to reasonably cover the common scenarios as learnt from historical data 112.

Advantageously, embodiments of the present invention address the challenge of optimization of revenue or other quality of service metrics by maximizing the number of deployments hosted in the system and admitting the right kinds of requests. The admission policy needs to be implemented online, as decisions need to be made at the time a deployment request arrives without knowing the future sequence of virtual machines arrivals.

Consistent with some embodiments of the present invention, historical data 112 may include any of the following parameters: type of resources, lifetime of requests, revenues of admitted requests, arrival process of requests, and distribution of prioritized requests. Using simulation model 122, historical data 112 is used to forecast the future arrival rate, lifetime, and specific resource requirements for each type of deployment request.

Consistent with some embodiments of the present invention, admission unit 150 may further be configured to apply the admission policy to incoming deployment requests issued to the admission unit for optimizing quality of service of the computer resources network.

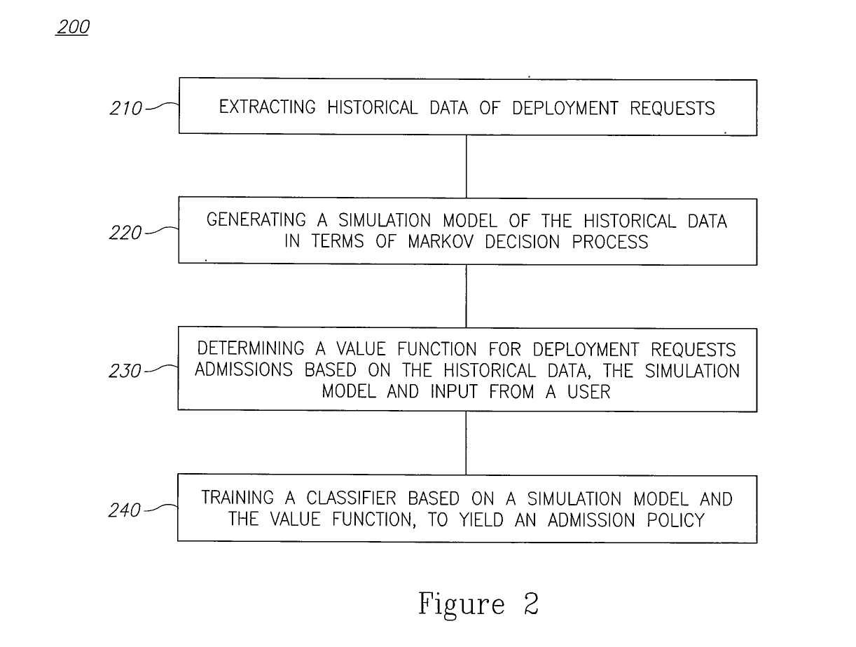

FIG. 2 is a high level flowchart diagram illustrating a method 200 according to some embodiments of the invention. It is understood that method 200 may be carried out by software or hardware other than the aforementioned architecture of system 100. However, for the sake of simplicity, the discussion of the stages of method 200 is illustrated herein in conjunction with the components of system 100. Method 200 starts with the off-line stage of extracting 210, possibly using statistical data extractor 110, historical data of deployment requests issued to an admission unit of a computer resources network. The method goes on to the stage of generating 220, possibly using Markov decision process simulator 120, a simulation model based on the extracted historical data and resources specifications of the computer resources network, in terms of a Markov decision process. The method then carries out a determining 230, possibly via value function generator 130, a value function for deployment requests admissions. Then, the method goes on to training 240, possibly using machine learning unit 140, a classifier based on the simulation model and the value function, to yield an admission policy usable for processing incoming deployment requests.

The reminder of the description illustrates in a non-limiting manner, an exemplary implementation of the simulation model as a Markov decision process and the admission policy derived from it. In a non-limiting example, based on historical data 112 and the specifications of computing resource network 10, the following parameters may be extracted:

VM requests type i=1, . . . , I Deployment requests of virtual machines
rᵢ—Revenue per time unit from VM request of type i
Aᵢ—Arrival process of VM request of type i with rate λᵢ
Tᵢ—lifetime of VM request of type i with mean tᵢ
Cloud Resource types j=disk, cpu, memory=1 . . . J
dᵢⱼ—Resource requirement of type j from VM type i
Node k=1 . . . K
cₖᵢ—maximal capacity of resource j on node k

In the following notation, the admission problem is illustrated as Markov Decision Problem (MDP) M=(S,A,P,R), with a state space S, admissible decision space A(s); s S, and a transition distribution function ps;a (y) indicating the probability to move to state y from state x when taking action a. Moreover, r(s, a) denotes the revenue of taking decision a when being in state s. The objective is to calculate an optimal policy π: S->A that yields the minimal long-run average cost provided as expression (1) below:

$$V ( {s}_{0} ) = {\sum }_{t = 0}^{∞} {γ}^{t} E [ r ( {s}_{t} , a ) \vert {s}_{0} ] \qquad ( 1 )$$

Wherein S=((a 11, . . . , aIK))—number hosted on each node of each type; A={(d1, . . . , dI)}—Binary decision vector, where dᵢ=1 if decide to admit VM request of type I, and di=0 if the decision is to reject; R(s, a)=E[r(s,a,w)] where r(s,a,w) is the reward of VM request of type i(w) if the action aᵢ is to admit, and 0 otherwise. The reward can be actual monetary units or some other QoS such as a blocking rate.

The parameters to this Markov decision process, namely the transition probabilities and the reward function, are evaluated from the aforementioned gathered historical data. In order to compute the value function, we run simulation and on each visited state we update our value function approximation V provided by expression (2) below:

V(s)=max_{—}aR(s,a)+E_{—}a[V(s′)] (2)

Eventually, an optimal policy may be derived by setting the decision in each state to be the one that maximize the immediate reward plus the expected value of the state that follows which depends on that decision. The optimal policy may be usable to generate sample of states features and their corresponding decisions.

An example of this sample is given below in table (1) shown below:

TABLE (1)

| | Number of Hosted | CPU usage level | |
|---|---|---|---|
| VM request | “A” type VM on | on most available | |
| type | Node #1 | node | Decision |
| C | 1 | 20% | ADMIT |
| B | 4 | 75% | REJECT |
| A | 2 | 45% | REJECT |
| A | 7 | 80% | ADMIT |

Following from table (1), depending on the current deployment request type and the actual physical resources available, different decisions are carried out over the decision tree. As discussed above, theses decision rules are simple to implement in real-time by the admission unit.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium: A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising:
extracting historical data of deployment requests issued to an admission unit of a computer resources network;
generating a simulation model based on the extracted historical data and resources specifications of the computer resources network, in terms of a Markov decision process;
determining a value function for deployment requests admissions; and
training a classifier based on the simulation model and the value function, to yield an admission policy usable for processing incoming deployment requests,
wherein at least one of: the extracting, the generating, and the determining, and the training is carried out in operative association with at least one computer processor.

2. The method according to claim 1, further comprising applying the admission policy to incoming deployment requests issued to the admission unit for optimizing quality of service of the computer resources network.

3. The method according to claim 1, wherein the simulation model is indicative of a Markov decision process in which transition probabilities and a reward function are based upon the extracted historical data.

4. The method according to claim 1, wherein the historical data comprises at least one of: type of resources, lifetime of requests, revenues of admitted requests, arrival process of requests, and resource requirements thereof.

5. The method according to claim 1, wherein the value function is generated based at least partially on: the simulation model, the historical data, and input from a user.

6. The method according to claim 1, wherein the computing resources network comprises at least one of: storage resources, memory resources, and processing resources.

7. The method according to claim 1, wherein the admission policy contains rules of admission, each rule comprises one or more condition checks associated with a type of the deployment request determined by the classifier and a physical resource requirement of the computer resources network.

8. A system comprising:
a statistical data extractor configured to extract historical data of deployment requests issued to an admission unit of a computer resources network;
a Markov decision process simulator configured to generate a simulation model based on the extracted historical data and resources specifications of the computer resources network, in terms of a Markov decision process;
a value function generator configured to determine a value function for deployment requests admissions; and
a machine learning unit configured to train a classifier based on the simulation model and the value function, to yield an admission policy usable for processing incoming deployment requests,
wherein at least one of: the extractor, the simulator, the generator, and the machine learning unit is carried out in operative association with at least one computer processor.

9. The system according to claim 8, wherein the admission unit is further configured to apply the admission policy to incoming deployment requests issued to the admission unit for optimizing quality of service of the computer resources network.

10. The system according to claim 8, wherein the simulation model is indicative of a Markov decision process in which transition probabilities and a reward function are based upon the extracted historical data.

11. The system according to claim 8, wherein the historical data comprises at least one of: type of resources, lifetime of requests, revenues of admitted requests, arrival process of requests, and resource requirements thereof.

12. The system according to claim 8, wherein the value function generator is further configured to generate the value function based at least partially on: the simulation model, the historical data, and an input from a user.

13. The system according to claim 8, wherein the computing resources network comprises at least one of: storage resources, memory resources, and processing resources.

14. The system according to claim 8, wherein the admission policy contains rules of admission, each rule comprises one or more condition checks associated with a type of the deployment request determined by the classifier and a physical resource requirement of the computer resources network.

15. A computer program product comprising:
a computer readable storage medium having computer readable program embodied therewith, the computer readable program comprising:
computer readable program configured to extract historical data of deployment requests issued to an admission unit of a computer resources network;
computer readable program configured to generate a simulation model based on the extracted historical data and resources specifications of the computer resources network, in terms of a Markov decision process;
computer readable program configured to determine a value function for deployment requests admissions; and
computer readable program configured to train a classifier based on the simulation model and the value function, to yield an admission policy usable for processing incoming deployment requests.

16. The computer program product according to claim 15, further comprising computer readable program configured to apply the admission policy to incoming deployment requests issued to the admission unit for optimizing quality of service of the computer resources network.

17. The computer program product according to claim 15, wherein the simulation model is indicative of a Markov decision process in which transition probabilities and a reward function are based upon the extracted historical data.

18. The computer program product according to claim 15, wherein the historical data comprises at least one of: type of resources, lifetime of requests, revenues of admitted requests, arrival process of requests, and resource requirements thereof.

19. The computer program product according to claim 15, wherein the value function is generated based at least partially on: the simulation model, the historical data, and an input from a user.

20. The computer program product according to claim 15, wherein the computing resources network comprises at least one of: storage resources, memory resources, and processing resources.
